(19) United States
(12) Patent Application Publication
(10) Pub. No.: US 2012/0081615 A1
(43) Pub. Date: Apr. 5, 2012

(54) REMOTE CONTROL

(76) Inventors: Ephraim D. Starr, Rancho Palos Verdes, CA (US); Howard J. Locker, Cary, NC (US); James S. Rutledge, Durham, NC (US); Justin T. Dubs, Durham, NC (US)

(21) Appl. No.: 12/895,321

(22) Filed: Sep. 30, 2010

(51) Int. Cl. H04N 5/44; G06F 3/041

(52) U.S. Cl. 348/734; 348/E05.096; 345/173

(57) ABSTRACT

An apparatus includes a display, a communication interface, circuitry configured to receive information via the communication interface via a handshake process where the information includes identifying information for a television unit, and circuitry configured to render a graphical remote control to the display based at least in part on received identifying information for a television unit. Various other apparatuses, systems, methods, etc., are also disclosed.

### TECHNICAL FIELD

Subject matter disclosed herein generally relates to techniques for controlling display of information.

### BACKGROUND

Given the increasingly larger number of television channels (i.e., often in the hundreds) and television functions, it can be difficult to navigate the myriad of channels and functions using traditional on-screen television guide menus and traditional remote controls. As to television functions, in addition to traditional functions such as volume, brightness, etc., many newer televisions allow for user control of display formats, environment modes, input sources, pixel shift function, etc. In turn, remote controls have become more complicated, typically via a plethora of buttons and small print to indicate function. As newer technologies emerge and become integrated into televisions, the conventional approach to remote controls increasingly proves inadequate. As described herein, various technologies provide for enhanced remote control.

### SUMMARY

An apparatus includes a display, a communication interface, circuitry configured to receive information via the communication interface via a handshake process where the information includes identifying information for a television unit, and circuitry configured to render a graphical remote control to the display based at least in part on received identifying information for a television unit. Various other apparatuses, systems, methods, etc., are also disclosed.

### BRIEF DESCRIPTION OF THE DRAWINGS

Features and advantages of the described implementations can be more readily understood by reference to the following description taken in conjunction with examples of the accompanying drawings.

FIG. 1 is a diagram of a system that includes a control device and a television unit;

FIG. 2 is a diagram of a control device in communication with a television unit;

FIG. 3 is a diagram of a graphical user interface displaying a graphical representation of a remote control;

FIG. 4 is a diagram of a graphical user interface of a control device for controlling display of media content on a television unit;

FIG. 5 is a diagram of a scheme for distributing modules for download to a computing device to provide remote control functionality to a computing device;

FIG. 6 is a diagram of a control device and a television unit where information received by the control device can trigger an interrupt and subsequent transmission of one or more instructions to the television unit;

FIG. 7 is a diagram of an example of a graphical user interface for configured logic for one or more interrupts and corresponding action; and

FIG. 8 is a diagram of an example of a machine, which may be a hand-holdable device or other apparatus.

### DETAILED DESCRIPTION

The following description includes the best mode presently contemplated for practicing the described implementations. This description is not to be taken in a limiting sense, but rather is made merely for the purpose of describing the general principles of the implementations. The scope of the invention should be ascertained with reference to the issued claims.

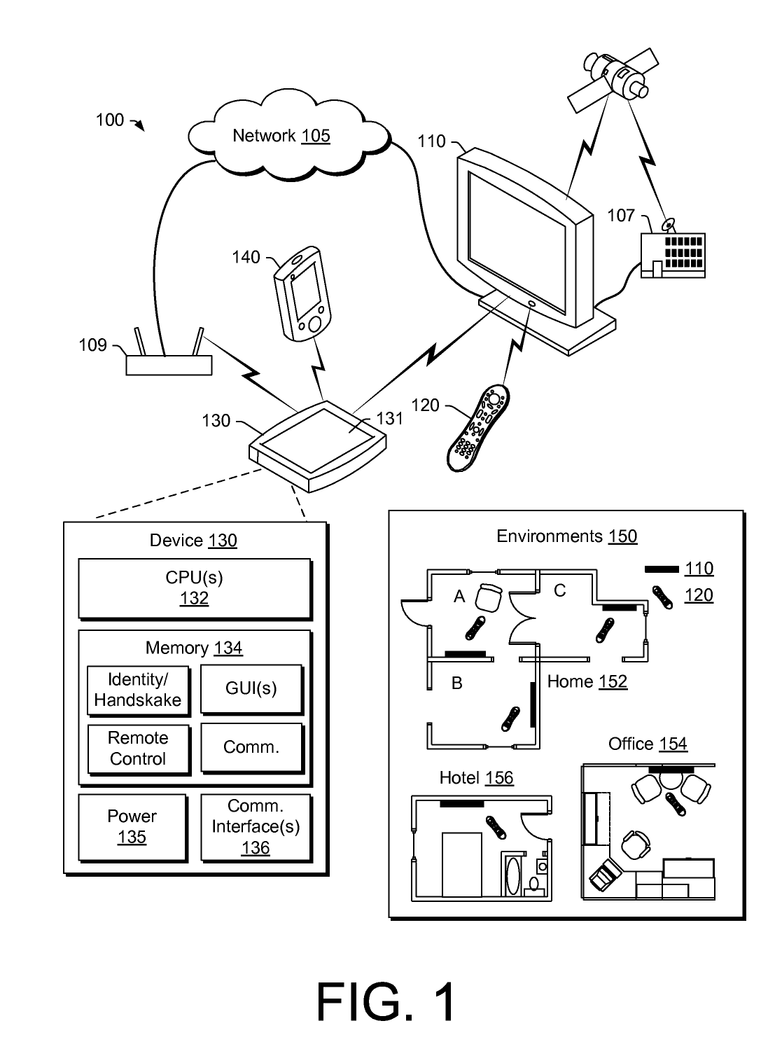

FIG. 1 shows an example of a system 100 with a control device 130 configured to control a television unit 110. In the example of FIG. 1, the television unit 110 may be controlled by a conventional remote control 120, for example, to select broadcast media content broadcast or distributed via a cable or satellite provider 107. The television unit 110 may be configured for communication via a network 105. In the example of FIG. 1, a network device 109 allows for one or more devices to communicate via the network 105. For example, the control device 130 may be configured to communicate with the network device 109 and one or more other devices such as the device 140 (e.g., a personal data assistant, a video camera, a cell phone, etc.) may be configured to communicate with the network device 109.

The control device 130 includes a display 131 optionally configured with touch sensor circuitry, one or more processors 132, memory 134, a power source 135 and one or more communication interfaces 136. The memory 134 may store modules such as an identity/handshake module, a remote control module, one or more graphical user interface modules (GUIs) and a communication module. For example, the identity/handshake module may be configured with instructions to identify one or more components in an environment optionally via a handshake process. A handshake process is, in general, a process by which two devices initiate communication with each other.

As described herein, a control device can receive identifying information about a television unit to facilitate control of the television unit. Such information may be transmitted to a control device via a beacon where the control device can receive the information and, in turn, transmit one or more control signals to control a television unit associated with the identifying information. Alternatively, or in addition to, a control device may emit a beacon that another device can receive and initiate a response thereto to allow the control device to acquire identifying information about a television unit.

In various examples, a control device and a television unit perform a handshake whereby the control device is able to identify the type of television unit and hence control instructions, algorithms, etc., to facilitate control of the television unit. Such a handshake process may be initiated by a control device or by a television unit. In some examples, a third device may initiate a handshake process (e.g., a network device) that allows a control device to acquire identifying information about a television unit.

As described herein, a control device may be configured to receive information via one or more types of interfaces (e.g., wired or wireless such as infrared, ultrasound, radio or microwave frequency, etc.) and by one or more types of protocols.

With respect to a remote control module, the device 130 may include a database of various types of remote controls and associated commands and functionality. Such a module may provide information to a GUI module that includes, for example, skins, layouts, buttons, content windows, flyouts, balloons, etc., suitable for display on the display 131 to facilitate control of a television unit. A communication module may provide instructions for types of communication such that commands entered via a control device may be ultimately communicated to a television unit (e.g., directly or indirectly). For example, if a television unit has an IP address on a network as well as an IR interface, a communication module may cause a GUI to display such communication options to facilitate control of the television unit; noting that IP control may be indirect via a network device (e.g., a router) and that IR communication may be direct via an IR sensor. In situations where a television unit includes router functionality, IP communication may be direct between a control device and the television unit (e.g., a television unit as a “hot spot”).

As described herein, the control device 130 is, in general, portable. Accordingly, a user may transport the device 130 to one or more locations or optionally even communicate with one or more television units (e.g., directly or indirectly) while situation in a single location. FIG. 1 shows various examples of environments 150 where each environment includes at least one television unit. In a home environment 152, three rooms (A, B and C) are shown where each room includes a television unit 110 and optionally a conventional remote control 120. In the home environment 152, each of the television units may differ as to type, manufacturer, features, etc. In an office environment 154, a television unit 110 is shown along with a conventional remote control 120. Similarly, in a hotel environment 156, a television unit 110 is shown along with a conventional remote control 120.

As described herein, a control device such as the control device 130 may be configured to control various different television units optionally in various different environments. For example, in the home environment 152, while seated in room A, a control device may become aware of the three television units, which may have different features. The control device may display a remote control GUI for all three simultaneously, display three remote control GUIs simultaneously or may display a control that allow for selection of one of three different remote control GUIs where each GUI is configured differently according to features of each television unit. In these examples, a user can touch a display of the control device and cause the device to issue one or more control signals to control one or more of the television units. In an office example, upon arriving in an office environment, a control device may discover a television unit and automatically display a GUI configured for remote control of the television unit. Similarly, in a hotel environment, a control device may discover a television unit and automatically display a GUI configured for remote control of the television unit.

As described herein, a control device may store, locally or remotely, a listing of discovered television units. A control device may include a remote control module configured to customize GUIs and optionally functionality associated with one or more discovered television units. For example, where an office television unit is used primarily for display of news media, a control device setting may allow for partitioning of a screen into sections for a display of a variety of news media channels with a navigable highlighted screen providing for audio. Where a hotel television unit is used primarily for watching movies, a control device setting may allow for selection of an audio clipping algorithm to ensure that sound levels do not exceed a certain limit in dB (e.g., to avoid disturbing neighboring guests). As to home television units, a control device may include various settings that allow for customization to suit a user's taste or content to be displayed on a television unit. A control device may include a default option, which may be a graphical rendering of a conventional remote control such as the remote control that was provided with the television unit by a manufacturer.

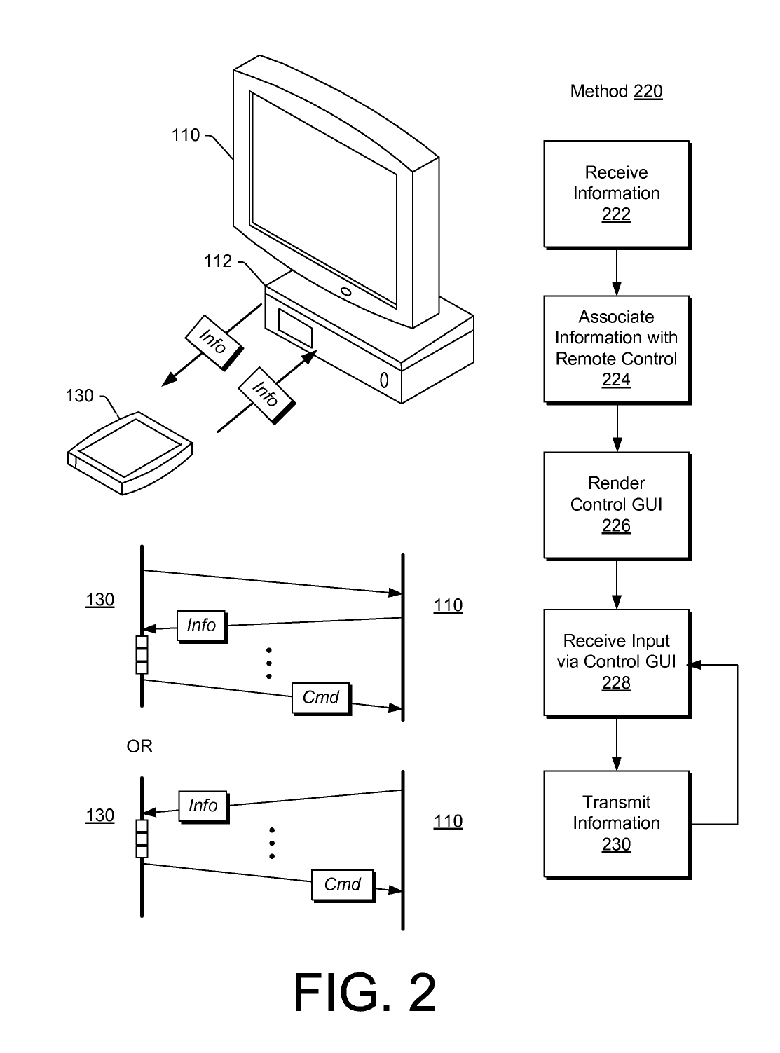

FIG. 2 shows a television unit 110, an optional set-top box (STB) 112 (e.g., which may be part of a television unit) and a control device 130 along with a method 220. In the example of FIG. 2, the method 220 includes a reception block 222 for receiving identifying information for a television unit, an association block 224 for associating the identifying information with a remote control, a rendering block 226 for rendering a graphical representation of the remote control to a touch-sensitive display, a reception block 228 for receiving input via the touch-sensitive display and a transmission block 230 for transmitting information according to a television unit-implementable communication protocol where the information may instruct a television unit (e.g., to perform a function such as a function to receive video content from a broadcast network). As indicated by an arrow from the transmission block 230 to the reception block 228, after an initial identification, a control loop may be repeated via additional received input.

FIG. 2 also shows communication timelines for a scenario where the control device 130 initiates communication and for a scenario where the television unit 110 initiates communication. In general, a television unit provides information sufficient to identify control functions, which may identify one or more particular conventional remote controls. Where a television unit includes a STB, a STB may be configured to provide information as to functions, one or more particular conventional remote controls, etc. For example, consider a service such as the TiVo® service (TiVo Inc., Alviso, Calif.) that includes a STB with a specific physical remote control. The STB may provide information that allows a control device to replicate the functionality of the specific physical remote control. As described herein, a television unit can include a STB and, for example, communicated information as to identity of a television unit may be information as to identity of a STB.

Referring again to the timelines, a timeline for a Bluetooth® wireless technology (Bluetooth SIG, Inc.) communication may include multiple receptions prior to establishing a communication session. In general, connections between Bluetooth® enabled electronic devices allow these devices to communicate wirelessly through short-range, ad hoc networks known as piconets. Piconets can be established dynamically and automatically as Bluetooth® enabled devices enter and leave radio proximity. In general, each device in a piconet can also simultaneously communicate with multiple other devices within that single piconet and each device can also belong to several piconets simultaneously.

As described herein, a method may include receiving information according to a Bluetooth® communication protocol or other protocol. As to associating received information, a method may include transmitting at least some of the identifying information via an IP network interface and, responsive to the transmitting, receiving information via the IP network interface (e.g., where remote control information for a television unit is stored remotely). As to receiving input, a method may include receiving input from one or more rendered graphical buttons which correspond to one or more physical buttons of a represented physical remote control.

As described herein, a control device may include circuitry configured for rendering thumbnails of video content to a touch-sensitive display. In such an example, a method may include receiving input via the touch-sensitive display where one or more touches correspond to one or more of the rendered thumbnails.

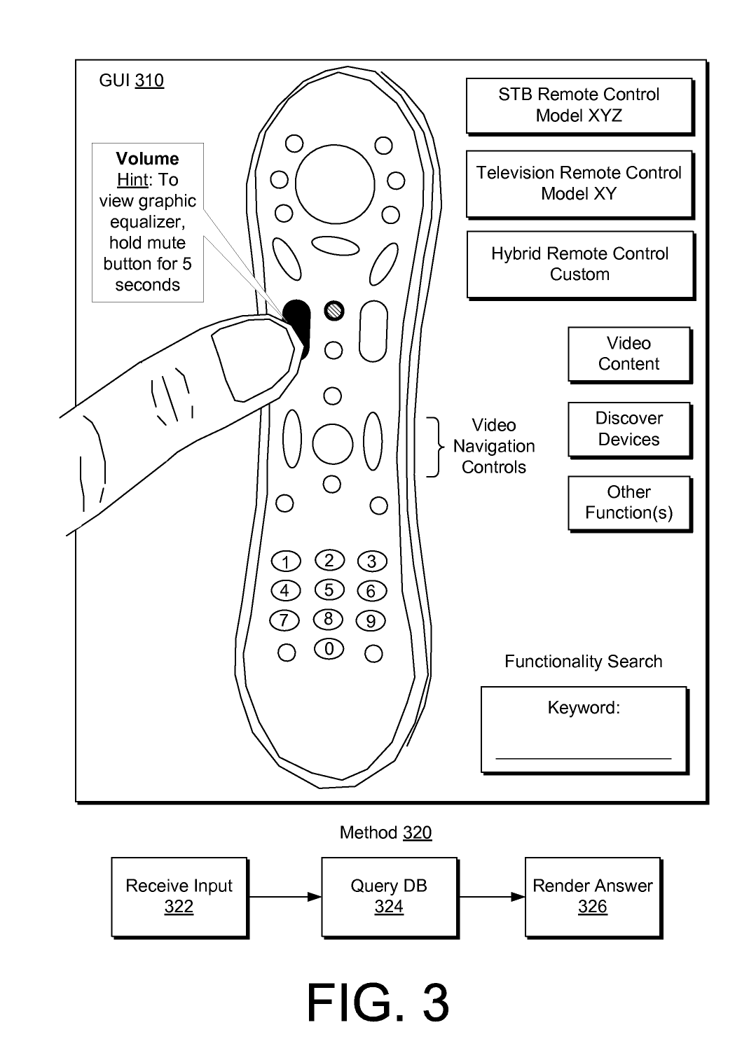

FIG. 3 shows a GUI 310 and a method 320. The GUI 310 is rendered on a touch-sensitive display of a control device such as the device 130 of FIG. 1. In the example of FIG. 3, the GUI 310 shows a rendering of a physical remote control and optionally various control graphics. A control device may receive input via the GUI 310, for example, when a user touches a displayed feature of the remote control. In response, the control device may cause a GUI to highlight the touched feature to ensure that the user touched the correct feature. As shown, a user has selected a button and, in response, the GUI 310 displays the function of the button (“Volume”) and optionally additional information (e.g., “Hint: To view graphical equalizer, hold mute button for 5 seconds”). In some instances, the additional information is not necessarily intuitive, i.e., how would a user know that an equalizer was accessible via the remote by holding down another button. In the example of FIG. 3, the button related to the “Volume” button is highlighted (e.g., colored, blinking, etc.) such that a user may readily locate the associated feature. In another example, consider a control device receiving touch input as to one of the video navigation control buttons. In such an example, all related buttons may be displayed by a GUI of a control device in a particular highlight color and assistance instructions may be displayed for that button and optionally one or more other buttons where the other buttons are highlighted, for example, via blinking.

FIG. 3 also shows various other control graphics such as a STB remote control, a television remote control or a hybrid remote control (e.g., television unit remote controls). A user may select one of these graphics and cause a control device to display a GUI for a corresponding type of remote control. Other control graphics include a video content graphic, a discover device graphic and other functions graphic. Yet further, the GUI 310 shows a functionality search window that allows a user to enter a keyword. Such functionality may be related to a remote control, a television unit, a service provider, etc.

The method 320 includes a reception block 322 for receiving input, for example, via the GUI 310. In a query block 324, the method 320 queries a database (DB), which may be local or remote as to information associated with the received input. In a render block 326, the query result is used to render an answer responsive to the received input. For example, the received input may correspond to the volume button as shown. In turn, a control device may search a local data store or a remote data store as to the function of the selected button. An option may be enabled on a control device that also returns “hints” or, more generally, information that extends beyond the mere function of a button. The returned information may be rendered, as appropriate, to thereby visually indicate (and optionally audibly indicate) the function of the selected button. Accordingly, through use of a control device such as the device 130, a user may become quite familiar with basic and even previously unknown features of a conventional remote control and, optionally, custom features specific to the control device that extend beyond those of a conventional remote control.

As described herein, a control device may be configured to receive multi-touch commands such as pinch and expand to zoom in or out with respect to a rendered remote control.

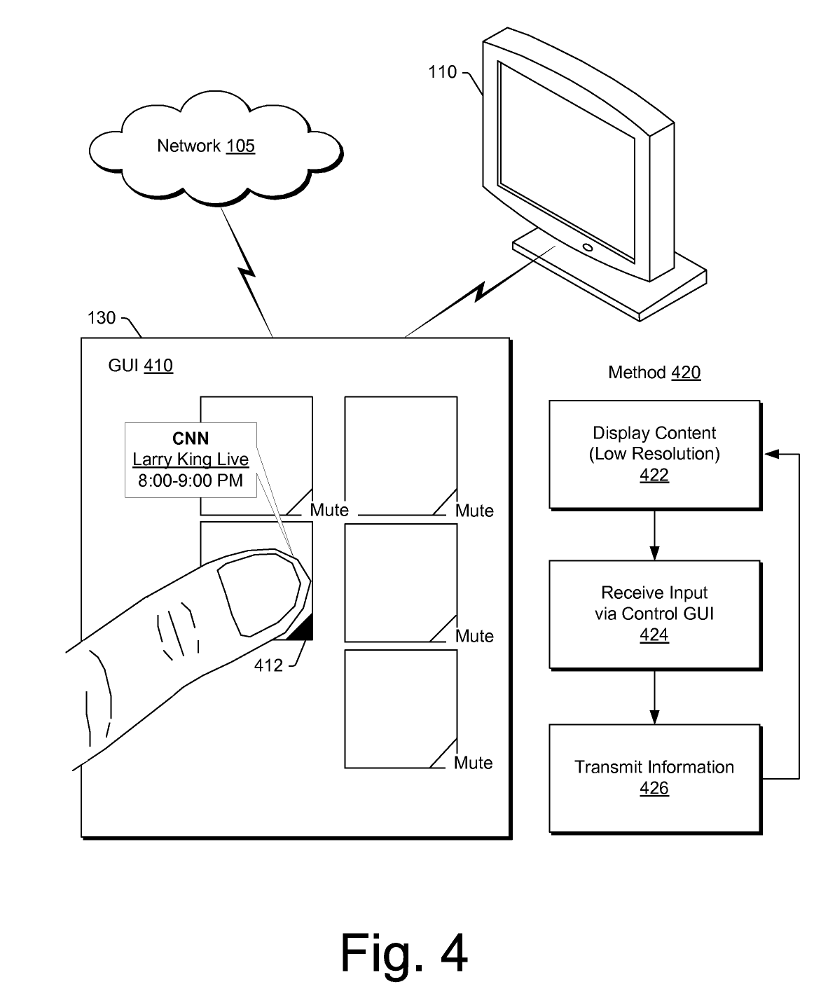

FIG. 4 shows a GUI 410 and an associated method 420. In the example of FIG. 4, the GUI 410 displays video thumbnails of some currently available media content (e.g., such as news, sport events, shows, movies, etc.). The displayed content may be in low-resolution and provided via a network connection. The source of the content may be a service provider such as a cable company (e.g., consider providers that provide Internet and cable television over a single connection). According to the method 420, a display block 422 displays content via a control device, a reception block 424 receives input via a control GUI rendered by the control device and a transmission block 426 transmits information responsive to the received input, directly or indirectly, to a television unit. For example, the control device 130 may render the GUI 410 to display low resolution video thumbnails of media content from a service provider, a user may select one of the video thumbnails, which causes the control device to receive input, and, responsive to the input, the control device may transmit an instruction to a television unit to thereby display high definition media content that corresponds to the selected video thumbnail. In the example of FIG. 4, the control device 130 can operate as a remote control that includes circuitry configured to render the GUI 410 as a graphical remote control to a display. In the foregoing example, the control device 130 can include circuitry configured to receive information via a wireless communication interface (e.g., via a handshake process) where the information includes identifying information for a television unit. In such an example, the control device 130 can configure itself for remote control of a television unit associated with the identifying information. While the example of FIG. 4 shows a particular arrangement of graphical features, as described herein, a remote control device such as the control device 130 may be configured to present any of a variety of indicia to a display (e.g., via one or more GUIs) where the control device is in a remote control mode. The remote control mode of a control device may optionally become available upon user selection (e.g., via GUI or other interface) or proximity of the remote control to a device such as a television, a STB, etc. (e.g., GUI appears or changes appearance responsive to proximity).

As described herein, a control device may render the GUI 410 and be configured to receive multiple touches where each touch corresponds to a displayed video thumbnail and, in response to such input, the control device may transmit instructions to a television unit to display all of the selected video media content simultaneously in a split screen display. The GUI 410 may further provide for audio selection via a graphic 412 to thereby transmit an instruction that causes one video to have active audio or, alternatively, all but one of the videos to be muted (see, e.g., bottom right corner where filled triangle represented not muted).

As described herein, a control device can include a display, a communication interface, circuitry configured to receive information via the communication interface via a handshake process wherein the information includes identifying information for a television unit and circuitry configured to render a graphical remote control to the display based at least in part on received identifying information for a television unit. In such an example, the display may be a touch-sensitive display where the device includes circuitry configured to receive input via the touch-sensitive display (e.g., where the input corresponds to one or more graphical buttons of the graphical remote control). As mentioned with respect to the example of FIG. 3, a control device can include circuitry configured to render instructional information to its display, for example, where the instructional information includes instructions for operation of the graphical remote control (or a television unit).

As shown in the example of FIG. 4, a control device can be configured with a touch-sensitive display and circuitry configured to render thumbnails of video content to the display, circuitry configured to receive input corresponding to one or more of the thumbnails, and circuitry configured to transmit information responsive to receipt of input via the touch-sensitive display, the input corresponding to one or more of the thumbnails. In such an example, the thumbnails may be video thumbnails, optionally in a low resolution format that allows for media content for multiple video thumbnails to be received and displayed for a given bandwidth and processing capability. Such thumbnails may optionally be video thumbnails of video content currently available via one or more broadcast networks. As mentioned, a user may select via touch one or more thumbnails such that a control device transmits, responsive to receipt of input via the touch-sensitive display, information to instruct a television unit to render video content associated with one or more of the selected thumbnails. Accordingly, such information may instruct a television unit to render simultaneously video content associated with two or more of the thumbnails.

In the example of FIG. 3, the remote control depicted includes some features arranged as in a physical TiVo® remote control. As described herein, a control device may include circuitry configured to render an arrangement of at least some features of a graphical remote control where the arrangement corresponds to an arrangement of features of a physical remote control.

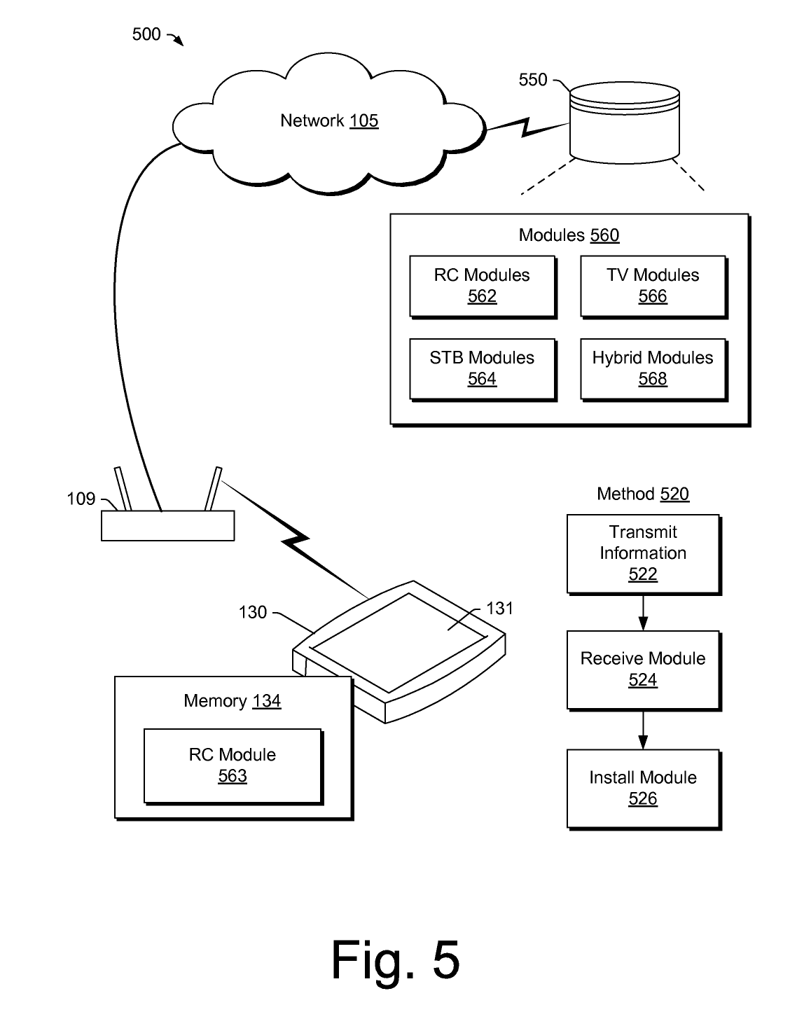

FIG. 5 shows an example of a module distribution scheme 500 for distributing modules for installation by a computing device to thereby configure the computing device to operate as a control device 130. In the example of FIG. 5, a data store 550 includes various modules 560 such as remote control specific modules 562, STB specific modules 564, TV specific modules 566 and hybrid modules 568. A control device 130 includes memory 134 for storing a copy of a remote control module 563 (e.g., one of the remote control modules 562). Such a module may be installed to allow the control device 130 to control a television unit.

According to a method 520, in a transmission block 522, a computing device transmits information, which may include characteristics of the computing device (e.g., OS, other software, communication capabilities, etc.). In response to transmitting such information, a reception block 524 receives a module configured accordingly. In an installation block 526, the computing device installs the module to thereby provide the computing device with functionality to operate as a control device such as the control device 130. With reference to the device 130, in the scenario of FIG. 5, a user may have transmitted a specific remote control model ID and, in response, received the remote control module 563 as a specific one of the remote control modules 562.

As described herein, a module may provide for help or “wizard” functions. For example, with reference to the scheme of FIG. 5, the remote control module 562 may include information as to specific features of a physical remote control, which may be displayed by the control device 130 to assist a user. For the STB modules 564, each of these modules may include information for a particular STB. For the TV modules 566, each of these modules may include information for a particular TV. For the hybrid modules 568, each of these modules may include information for combinations of remote controls, combinations of TV, combinations of STB, combinations of a remote control and a TV or a STB, combinations of a TV and a STB, etc. As described herein, a television unit may be a TV or a STB or include a TV and a STB or optionally be a combined TV and STB device. A television unit may include multiple components to allow for such types of functionality.

As described herein, one or more computer-readable media (e.g., modules) can include processor-executable instructions to instruct a computing device to receive identifying information for a television unit, associate the identifying information with a remote control, render a graphical representation of the remote control to a touch-sensitive display, receive input via the touch-sensitive display and transmit information according to a television unit-implementable communication protocol where the information is sufficient to instruct a television unit to receive video content from a broadcast network. As explained with respect to FIG. 3, a module may include instructions to receive a keyword, to associate the keyword with a feature of a television unit and to render to the display information describing the feature. A module may include instructions to receive and render thumbnails of video content to a touch-sensitive display.

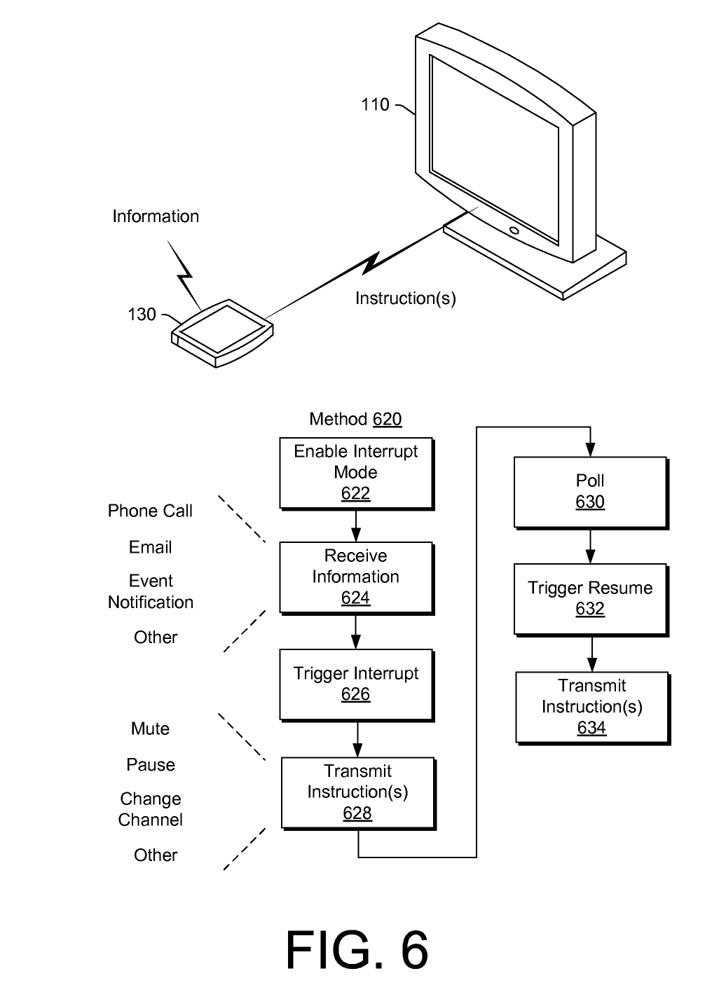

FIG. 6 shows a scenario where a control device 130 receives information and, in response, transmits an instruction to a television unit 110. A method 620 includes an enable block 622 for enabling an interrupt mode of a control device. A reception block 624 receives information and in response to receipt of the information, a trigger block 626 issues an interrupt. In response to the interrupt, at least one instruction is transmitted by the control device.

The type of information that leads to a trigger may optionally be selected, for example, such that only certain types of information trigger an interrupt. For example, a phone call where the control device is configured to receive phone calls or email where the control device is configured to receive emails, etc. In such examples, the interrupt functionality may be programmed to be specific to certain phone numbers or emails from certain people or organizations. A GUI may assist a user in selecting the types of information that cause an interrupt. Further, as described herein, an interrupt may consider the media content being displayed by a television unit. Consider a situation where someone is calling about a news event related to a company that is currently being aired. Accordingly, a GUI may allow a user to effectuate control logic such that if someone from company X calls while during display of news on a television unit, the control device issues an instruction to reduce volume by 10 dB (e.g., but not to mute). Thus, the instruction (or instructions) can optionally be selected by a user via a GUI or other set-up feature of a module.

After transmission of an instruction(s), the method 620 continues at a poll block 630 that polls a process. For example, where a phone call causes an interrupt, the poll block 630 may poll a process related to the phone functionality of the control device or where an email causes an interrupt, the poll block 630 may poll an email process. In various examples, a poll may operate to poll a timeout delay. Upon a poll event, the method 620 may trigger a resume signal or command. In turn, a transmit block 634 transmits one or more instructions to the television unit, for example, to resume viewing, listening, etc. In instances where a memory device such as a DVR is configured to record media content, a first instruction may be to pause viewing while a second instruction may be to resume viewing. For example, upon receipt of a phone call from person Y, the media content being displayed is paused while recording continues and upon termination of the phone call, media content is displayed starting from the point of the pause via the recording.

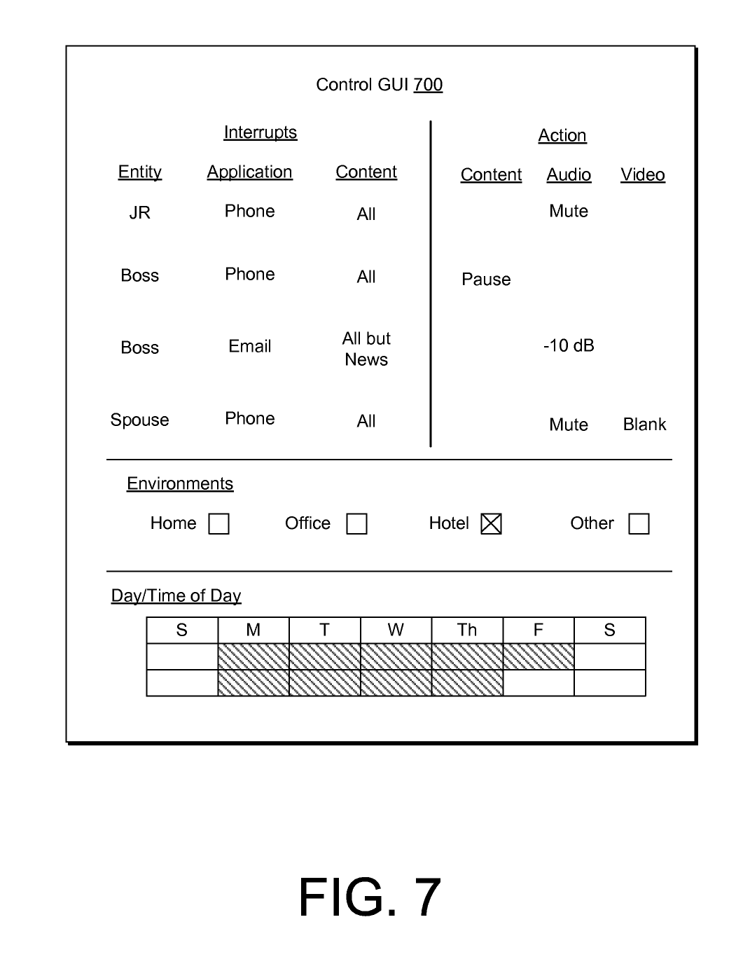

FIG. 7 shows an example of a control GUI 700 where a user can enter or select entities, applications, content as to interrupts and enter or select corresponding actions (e.g., content, audio, video, etc.). For example, for the entity “Boss”, if the control device receives a phone call from this entity, all content being displayed on the television unit will be paused. However, if an email is received from the entity “Boss”, all content but news will be decreased in volume by 10 dB. Accordingly, such an interface allows a user to construct logical rules where the control device is a multifunctional device configured to control a television unit. Further, the GUI 700 may include an option to associate the interrupts with one or more environments (e.g., home, office, hotel, other) and optionally day, time of day or both day and time of day. As described herein, an interrupt mode may be configured to respond to electronic communications. Electronic communications can include phone communications (e.g., phone calls), email communications (e.g., emails) and possibly other types of communications received electronically, which may be directed to an identifier such as a phone number, email address, messenger address, etc.

As described herein, a convenient hand-held touch screen device such as an iPad product (Apple Corporation, Cupertino, Calif.) may optionally be configured as a control device to provide easy access to, and control of, a myriad TV channels and functions. For example, a module may be downloaded and installed to provide a “TV remote control application”, which can convert an off-the-shelf touch screen device into a control device such as the control device 130.

As described herein, a control device may optionally be used to display available TV channels on display of the control device in a convenient format to allow for easy selection. For example, TV channels and brief programming descriptions can be made easier to read than on the traditional TV displays because the viewer can move the control device close to his or her eyes, which is more convenient than the viewer moving him or herself closer to the TV. Further, TV channels and programming descriptions can be made easier to read because the user can select the manner in which the control device displays this information. For example, one user-selectable option is to display the available TV channels not by chronological number, but by the type of programming (e.g., movies, sporting events, news, documentaries, new network programs, syndicated programs, etc.). A TV remote control application (or application for a STB, remote control or hybrid) can enable such an option, for example, using basic programming information that is transmitted in the metadata of the TV program transmission streams. In another example, a control device can display either static or live thumbnail pictures of the TV channels in real-time or near real-time.

A control device may be configured to allow a user to customize size of thumbnail pictures/videos (e.g., to fit 12 per display screen, 40 per display screen, or whatever the user prefers). The user can select the channel simply by touching (e.g., single or double-tapping) the thumbnail picture/video of the channel of choice.

As described herein, a control device may be configured to access and control functions (e.g., of a TV, STB or both). As mentioned, a control device can be configured to display an image of a traditional remote control, or even an image of the particular remote control that accompanied a particular user's TV or STB. Images for a particular remote control can be obtained through TV manufacturer instruction manuals or databases, with permission if necessary. As mentioned, a user may optionally use a control device just as he or she would use the traditional physical remote control—i.e., by tapping the numbers, buttons or icons of the display image that the correspond to the numbers, buttons or icons located on the physical remote control.

As described herein, a control application can implement a “help” or “wizard” feature to make it easier for a user to access and control TV or STB functions. For example, the display of a control device may have a space for entering a search term, which the user can enter by using available input methods (such as an on-screen key pad or by direct text entry using a stylus). A help function that responds to such a search can be implemented that guides the user to the particular numbers, buttons or icons that control to the function the user enquired about. For example, if the user enters “find cable” into the search box, the control device can be configured to display input sources attached to the TV and provide icons associated with each, so that the user may easily select “cable.” Such a feature is particularly convenient for parents of small children, who have been known to use the traditional physical remote to change the TV source to an unused input, thus creating a blank TV display that often befuddles overly tired parents of the small children.

As described herein, a control device may be configured to control functions such as those of a television or STB, for example, consider input source, picture format, brightness, etc.

A “help” or “wizard” feature may also be used to help a user select a desired TV channel, for example, by using an Internet connection to search programming content and display search results on the control device that represent real-time or near real-time programming in which the user might be interested. Consider a user interested in “professional cycling”, which may be entered into a search box. In response, a control application may automatically add additional information to refine the search. For example, the control application may direct the search to a particular Internet site that provides TV programming information specific to the user's TV service provider. Or the remote control application may add information such as location and local time to accompany the search. In this manner, a refined search is provided and pertinent search results are displayed. Thus, a user can easily navigate to the Tour of Flanders bicycle race if the user is interested professional cycling and happens to be watching TV when his or her service provider is transmitting a video broadcast of this great race.

As described herein, program guides and functions can be delivered to a control device in any of a variety of ways. Program and function selection information can be delivered to a TV or STB via the same path or via another path.

The term “circuit” or “circuitry” is used in the summary, description, and/or claims. As is well known in the art, the term “circuitry” includes all levels of available integration, e.g., from discrete logic circuits to the highest level of circuit integration such as VLSI, and includes programmable logic components programmed to perform the functions of an embodiment as well as general-purpose or special-purpose processors programmed with instructions to perform those functions. Such circuitry may optionally rely on one or more computer-readable media that includes computer-executable instructions. As described herein, a computer-readable medium may be a storage device (e.g., a memory card, a storage disk, etc.) and referred to as a computer-readable storage medium.

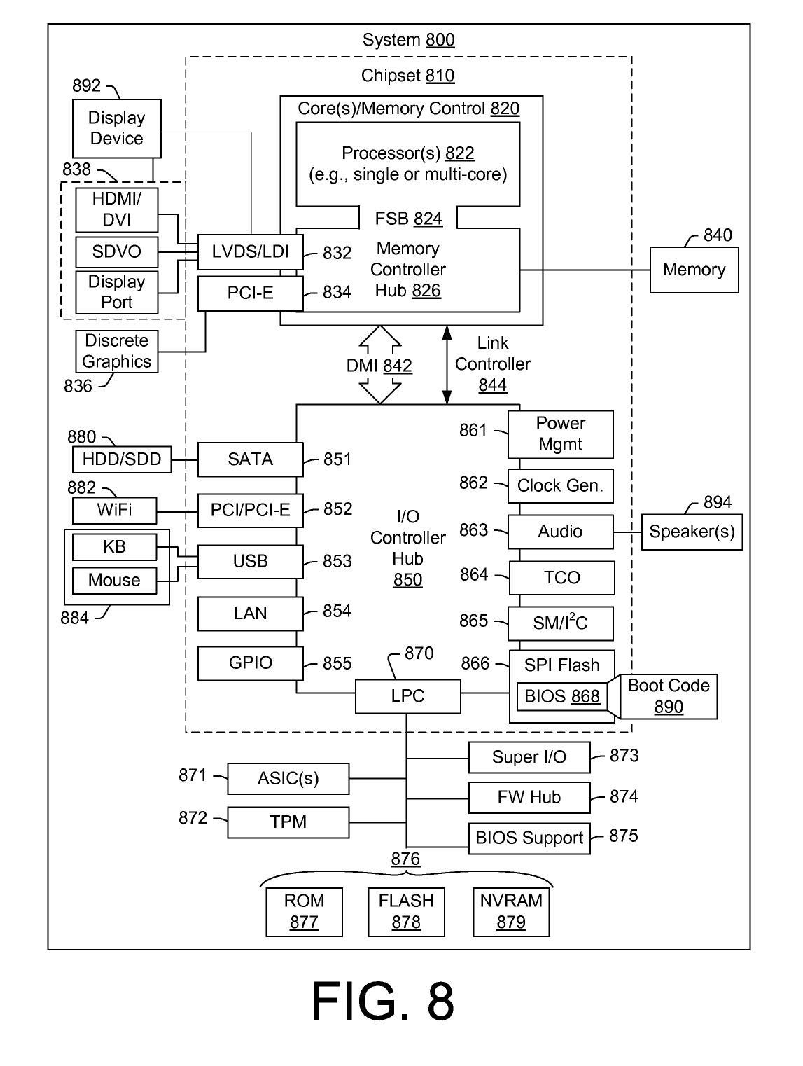

While various examples of circuits or circuitry have been discussed, FIG. 8 depicts a block diagram of an illustrative computer system 800. The system 800 may be a desktop computer system, such as one of the ThinkCentre® or ThinkPad® series of personal computers sold by Lenovo (US) Inc. of Morrisville, N.C., or a workstation computer, such as the ThinkStation®, which are sold by Lenovo (US) Inc. of Morrisville, N.C.; however, as apparent from the description herein, a satellite, a base, a server or other machine may include other features or only some of the features of the system 800. As described herein, a control device such as the control device 130 may include some of the features of the system 800.

As shown in FIG. 8, the system 800 includes a so-called chipset 810. A chipset refers to a group of integrated circuits, or chips, that are designed to work together. Chipsets are usually marketed as a single product (e.g., consider chipsets marketed under the brands INTEL®, AMD®, etc.).

In the example of FIG. 8, the chipset 810 has a particular architecture, which may vary to some extent depending on brand or manufacturer. The architecture of the chipset 810 includes a core and memory control group 820 and an I/O controller hub 850 that exchange information (e.g., data, signals, commands, etc.) via, for example, a direct management interface or direct media interface (DMI) 842 or a link controller 844. In the example of FIG. 8, the DMI 842 is a chip-to-chip interface (sometimes referred to as being a link between a “northbridge” and a “southbridge”).

The core and memory control group 820 include one or more processors 822 (e.g., single core or multi-core) and a memory controller hub 826 that exchange information via a front side bus (FSB) 824. As described herein, various components of the core and memory control group 820 may be integrated onto a single processor die, for example, to make a chip that supplants the conventional “northbridge” style architecture.

The memory controller hub 826 interfaces with memory 840. For example, the memory controller hub 826 may provide support for DDR SDRAM memory (e.g., DDR, DDR2, DDR3, etc.). In general, the memory 840 is a type of random-access memory (RAM). It is often referred to as “system memory”.

The memory controller hub 826 further includes a low-voltage differential signaling interface (LVDS) 832. The LVDS 832 may be a so-called LVDS Display Interface (LDI) for support of a display device 892 (e.g., a CRT, a flat panel, a projector, etc.). A block 838 includes some examples of technologies that may be supported via the LVDS interface 832 (e.g., serial digital video, HDMI/DVI, display port). The memory controller hub 826 also includes one or more PCI-express interfaces (PCI-E) 834, for example, for support of discrete graphics 836. Discrete graphics using a PCI-E interface has become an alternative approach to an accelerated graphics port (AGP). For example, the memory controller hub 826 may include a 16-lane (x16) PCI-E port for an external PCI-E-based graphics card. A system may include AGP or PCI-E for support of graphics.

The I/O hub controller 850 includes a variety of interfaces. The example of FIG. 8 includes a SATA interface 851, one or more PCI-E interfaces 852 (optionally one or more legacy PCI interfaces), one or more USB interfaces 853, a LAN interface 854 (more generally a network interface), a general purpose I/O interface (GPIO) 855, a low-pin count (LPC) interface 870, a power management interface 861, a clock generator interface 862, an audio interface 863 (e.g., for speakers 894), a total cost of operation (TCO) interface 864, a system management bus interface (e.g., a multi-master serial computer bus interface) 865, and a serial peripheral flash memory/controller interface (SPI Flash) 866, which, in the example of FIG. 8, includes BIOS 868 and boot code 890. With respect to network connections, the I/O hub controller 850 may include integrated gigabit Ethernet controller lines multiplexed with a PCI-E interface port. Other network features may operate independent of a PCI-E interface.

The interfaces of the I/O hub controller 850 provide for communication with various devices, networks, etc. For example, the SATA interface 851 provides for reading, writing or reading and writing information on one or more drives 880 such as HDDs, SDDs or a combination thereof. The I/O hub controller 850 may also include an advanced host controller interface (AHCI) to support one or more drives 880. The PCI-E interface 852 allows for wireless connections 882 to devices, networks, etc. The USB interface 853 provides for input devices 884 such as keyboards (KB), mice and various other devices (e.g., cameras, phones, storage, media players, etc.).

In the example of FIG. 8, the LPC interface 870 provides for use of one or more ASICs 871, a trusted platform module (TPM) 872, a super I/O 873, a firmware hub 874, BIOS support 875 as well as various types of memory 876 such as ROM 877, Flash 878, and non-volatile RAM (NVRAM) 879. With respect to the TPM 872, this module may be in the form of a chip that can be used to authenticate software and hardware devices. For example, a TPM may be capable of performing platform authentication and may be used to verify that a system seeking access is the expected system.

The system 800, upon power on, may be configured to execute boot code 890 for the BIOS 868, as stored within the SPI Flash 866, and thereafter processes data under the control of one or more operating systems and application software (e.g., stored in system memory 840). An operating system may be stored in any of a variety of locations and accessed, for example, according to instructions of the BIOS 868. Again, as described herein, a satellite, a base, a server or other machine may include fewer or more features than shown in the system 800 of FIG. 8.

### CONCLUSION

Although examples of methods, devices, systems, etc., have been described in language specific to structural features and/or methodological acts, it is to be understood that the subject matter defined in the appended claims is not necessarily limited to the specific features or acts described. Rather, the specific features and acts are disclosed as examples of forms of implementing the claimed methods, devices, systems, etc.

What is claimed is:

1. An apparatus comprising:
a display;
a wireless communication interface;
circuitry configured to receive information via the wireless communication interface via a handshake process wherein the information comprises identifying information for a television unit; and
circuitry configured to render a graphical remote control to the display based at least in part on received identifying information for a television unit.

2. The apparatus of claim 1 wherein the identifying information comprises identifying information for a television unit that comprises a set-top box.

3. The apparatus of claim 1 wherein the display comprises a touch-sensitive display and further comprising circuitry configured to receive input via the touch-sensitive display, the input corresponding to one or more graphical buttons of the graphical remote control.

4. The apparatus of claim 1 further comprising circuitry configured to render instructional information to the display wherein the instructional information comprises instructions for operation of the graphical remote control.

5. The apparatus of claim 4 wherein the instructional information comprises instructions for operation of a physical remote control associated with the identifying information for a television unit.

6. The apparatus of claim 1
wherein the display comprises a touch-sensitive display,
further comprising circuitry configured to render thumbnails of video content to the display,
further comprising circuitry configured to receive input corresponding to one or more of the thumbnails, and
further comprising circuitry configured to transmit information responsive to receipt of input via the touch-sensitive display, the input corresponding to one or more of the thumbnails.

7. The apparatus of claim 6 wherein at least some of the thumbnails comprise video thumbnails of video content currently available via one or more broadcast networks.

8. The apparatus of claim 6 wherein the information transmitted responsive to receipt of input via the touch-sensitive display comprises information to instruct a television unit to render video content associated with one or more of the thumbnails.

9. The apparatus of claim 8 wherein the information to instruct comprises information to instruct a television unit to render simultaneously video content associated with two or more of the thumbnails.

10. The apparatus of claim 1 wherein the circuitry configured to render renders an arrangement of at least some features of the graphical remote control wherein the arrangement corresponds to an arrangement of features of a physical remote control associated with the identifying information.

11. The apparatus of claim 1 further comprising circuitry configured to enable an interrupt mode, the interrupt mode configured to transmit at least one instruction to a television unit responsive to receipt of a phone call or an email by the apparatus.

12. A method comprising:
receiving identifying information for a television unit;
associating the identifying information with a remote control;
rendering a graphical representation of the remote control to a touch-sensitive display;
receiving input via the touch-sensitive display; and
transmitting information according to a television unit-implementable communication protocol wherein the information comprises information to instruct a television unit to receive video content from a broadcast network.

13. The method of claim 12 wherein the receiving receives information according to a Bluetooth® communication protocol.

14. The method of claim 12 wherein the associating comprises transmitting at least some of the identifying information via an IP network interface and, responsive to the transmitting, receiving information via the IP network interface.

15. The method of claim 12 wherein the receiving input via the touch-sensitive display comprises receiving input from one or more rendered graphical buttons which correspond to one or more physical buttons of the represented remote control.

16. The method of claim 12 further comprising rendering thumbnails of video content to the touch-sensitive display.

17. The method of claim 12 wherein the identifying information comprises identifying information for a television unit that comprises a set-top box.

18. One or more computer-readable media comprising processor-executable instructions to instruct a computing device to:
receive identifying information for a television unit;
associate the identifying information with a remote control;
render a graphical representation of the remote control to a touch-sensitive display;
receive input via the touch-sensitive display; and
transmit information according to a television unit-implementable communication protocol wherein the information comprises information to instruct a television unit to receive video content from a broadcast network.

19. The one or more computer-readable media of claim 18 comprising instructions to receive a keyword, to associate the keyword with a feature of a television unit and to render to the display information describing the feature.

20. The one or more computer-readable media of claim 18 comprising instructions to receive and render thumbnails of video content to the touch-sensitive display.
